(19) United States
(12) Patent Application Publication
(10) Pub. No.: US 2026/0238922 A1
(43) Pub. Date: Aug. 13, 2026

(54) METHOD FOR REDUCING SIGNAL DISTORTION IN AN ELECTRO-MECHANICAL TRANSDUCER BASED ON MAGNETIC FLUX MODES

(71) Applicant: Wolfgang Klippel, Dresden (DE)

(72) Inventor: Wolfgang Klippel, Dresden (DE)

(21) Appl. No.: 19/529,667

(22) Filed: Feb. 4, 2026

(30) Foreign Application Priority Data
Feb. 11, 2025 (DE) 102025000497.4

(51) Int. Cl. H04R 3/04; H04R 9/02; H04R 9/06; H04R 29/00

(52) U.S. Cl. CPC H04R 3/04; H04R 9/027; H04R 9/06; H04R 29/003

(57) ABSTRACT

The invention describes a method for reducing linear and nonlinear distortions in the output signal of an electromechanical transducer based on modal modeling of the magnetic field generated by an electric input current and magnets. The model employs modal decomposition to separate linear and nonlinear subsystems, with the free parameters determined from measurements and numerical simulations. Based on the identified model, the model states for a given input signal are computed, and the linear and nonlinear signal distortions are separated from the desired output. An analysis and diagnostic evaluation of these signal distortions reveals the physical causes and enables targeted design improvements to the transducer. In addition, the distortions in the output signal are converted into equivalent input distortions, which an electrical or digital controller actively compensates.

### CROSS-REFERENCE TO RELATED APPLICATION

This claims the benefit of German Patent Application No. DE 102025000497.4, filed Feb. 11, 2025, the content of which is hereby incorporated by reference in its entirety.

### DESCRIPTION OF THE INVENTION

### Field of Invention

The invention discloses a method for reducing the linear and nonlinear distortions in an output signal of an electromechanical transducer, which as a sensor converts a mechanical input signal (e.g. displacement x) into an electrical output signal (e.g. terminal voltage u_{C}) or as an actuator an electrical input signal (e.g. terminal voltage u_{C}) into a mechanical output signal (e.g. force Fₓ) with the help of a magnetic field.

The electromechanical transducer uses a movable drive element on which the force Fₓ and the displacement x act. This drive element can be designed as a voice coil, moving magnet, or iron armature, for example. This results in a wide range of technical applications, including electrodynamic microphones, loudspeakers, headphones, hearing aids, and vibration exciters (shakers).

The electromechanical transducer is an essential component for transmitting audio signals (e.g., music) and other technical signals over a wide frequency range. This results in linear and nonlinear signal distortion that degrades sound quality and reduces the effectiveness of modern control techniques, such as active compensation for background noise and echoes, and artificial changes to the directivity.

### STATE OF THE ART

The magnetic field in the electromechanical transducer considered here is nonconstant; it varies with time, which depends on the input current i_{C} and the drive element's displacement x. This creates an electrical induction voltage u_{I} and the driving force Fₓ.

This relationship can be modeled using Maxwell's equations and computed using modern numerical methods based on the finite element method (FEM). This analysis requires the transducer geometry and material properties and yields the relevant electromagnetic-field state variables at the sampling points. To facilitate the interpretation of these numerical simulation results and to compare them with results from other analytical methods, it is helpful to summarize field information into state variables corresponding to lumped elements in network modeling.

For example, a transducer with a voice coil can be described in the small-signal range and within a limited frequency range using only three parameters, which are sufficiently accurate for many applications. These are the DC resistance Rₑ, the voice coil's self-inductance Lₑ, and the Bl product (also called the force factor or coupling factor), which is used both to calculate the Laplace force (the Lorentz force integrated over the wire length) and to calculate the velocity-dependent induction voltage.

This simple model fails at high frequencies, where the induced currents in iron and other conductive materials (e.g., short-circuit rings) generate additional losses due to eddy currents, field displacement, and skin effect, requiring the introduction of a lossy inductance or semi-inductance, see K. Thorborg, C. Futtrup, in “Electrodynamic transducer model incorporating semi-inductance and means for shorting AC magnetization,” J. Audio Eng. Soc., vol. 59, (9), pp. 612-627 (2011). This extended linear model has a physical interpretation in terms of magnetic reluctance, in contrast to alternative models that describe the lossy inductance abstractly as a network of purely inductive and resistive elements (e.g., LₙRₙ model) or via fractional derivatives.

These linear models can only describe the electrodynamic transducer, i.e., the voice coil in the air gap, with small displacements from the resting position. At larger amplitudes, the transducer must be modeled as a nonlinear dynamical system to account for the emergence of nonlinear distortions and additional forces. An electromagnetic force (reluctance force) also arises, for example, in an electrodynamic transducer when the voice coil inductance L(x) varies with displacement x; see O. Munroe, A. Novak, and L. Simon, “Reluctance force modeling and compensation,” in J. Audio Eng. Soc, vol. 70, No. 3, pp. 177-184 (2022).

The publication by E. Santini, S. Teodori, “Modeling, FEM analysis and dynamic simulation of a moving coil loudspeaker”, in: 2014 International Symposium on Power Electronics, Electrical Drives, Automation and Motion, IEEE, 2014, pp. 1306-1312, describes the inductance L(x) and the force factor Bl(x) as functions of the voice coil displacement x, without taking into account the losses generated by eddy currents in the iron.

The disclosure document DE 10 2014 011 911 A1 describes a calculation method for the design of reluctance systems and a computer program that accounts for the nonlinearity of ferromagnetic materials but neglects the displacement x of the coil, magnet, or another drive element.

Under certain conditions, for example if the transducer does not contain a short-circuit ring, there is a direct relationship between the nonlinearity of the force factor Bl(x) and the voice coil nonlinearity L(x), as reported by F. T. Agerkvist and H. Franz in the publication “On the Interdependence of Loudspeaker Motor Nonlinearities” in 145th Audio Eng. Soc. Convention, October NY, USA (2018) (www.aes.org/e-lib/browse.cfm?elib=19784).

W. Klippel showed in the “Tutorial: Loudspeaker nonlinearities—causes, parameters, symptoms,” J. Audio Eng. Soc., vol. 54, (10), pp. 907-939, 2006, that the voice coil inductance L(i) changes with the input current i due to the nonlinear saturation of the iron and the hysteresis in the B(H) characteristic curve.

The well-known state-of-the-art models with lumped parameters define the inductances L(x) and L(i_{C}) and the force factor Bl(x) as static nonlinearities with no memory, and thus do not exhibit internal dynamics or frequency dependence. This assumption also uses the nonlinear LₙRₙ model, which has been formally extended for the large-signal range by the introduction of displacement-dependent inductances Lₙ(x) and resistors Rₙ(x) in the network, see the above-cited publication by O. Munroe et al (2022). This model provides a good approximation of lossy inductance when the voice coil is clamped at different positions (x_{DC}). However, the modeling error increases with the frequency of the alternating displacement x.

Networks with lumped parameters and system-theoretical models derived from them (often presented as block diagrams) currently form the basis for the simulation of the transfer behavior of the electrodynamic loudspeaker and the active compensation of the nonlinear distortions with adaptive nonlinear control methods in available signal processors, see the patent specification of W. Klippel, “Method and arrangement for controlling an electro-acoustical transducer”, US p B2 and the publication of H. Schurer, C. Slump, H. Cornelis, O. E. Herrmann, “Theoretical and experimental comparison of three methods for compensation of electrodynamic transducer nonlinearity”, in Journal of the Audio Engineering Society, 46, 1998, No. 9, pp. 723-740.

US 2017/0353795 A1 describes a method and arrangement for compensating for nonlinear loudspeaker distortion based on a model that does not take into account the losses caused by eddy currents in the iron.

However, the currently used lumped-parameter model inadequately describes the interactions between current and displacement dependencies and does not account for iron losses. A formal introduction of inductances Lₙ(x, i_{C}), resistors Rₙ(x, i_{C}), and force factor Bl(x, i_{C}), which depend on both the displacement x and the input current i_{C} of the voice coil, leads to a high modeling error that degrades the active compensation of the nonlinear distortions.

C. Lastrucci describes an actuator with a moving magnet in the publication “Electromechanical conversion system with moving magnets”—US 2013/0010999 A1. The nonlinear network model of the voice coil transducer is not formally transferable to this particular type of transducer. This is evident in the modelling of the driving force, which cannot be expressed as a Laplace force (Bl product). The losses due to induced currents and the nonlinear material properties of the iron (especially without lamination) generate considerable distortions in the output signal, which are not described by any suitable model at the present state of the art, and which is the basis for the assessment of these nonlinearities and the active distortion compensation.

W. Klippel disclosed a nonlinear network model for a balanced armature transducer used in hearing aids using an iron armature in a symmetrical magnet field in “Arrangement and method for converting an input signal into an output signal and for generating predefined transfer behavior between said input signal and said output signal,” U.S. Pat. No. 9,326,066, This model shows that the nonlinear saturation in the iron material produces dominant distortions in the output signal. However, this model cannot adequately capture the frequency dependence of losses due to induced currents and of field displacement (skin effect).

### Objectives of the Invention

The invention aims to develop a method that reduces linear and nonlinear distortions in electromechanical transducers by modifying the passive transducer design or through active compensation via digital signal processing and electrical control. The aim is to separate signal distortions from the undistorted input signal and to describe their generation by an electromagnetic model.

This model is intended to capture the critical properties of the transducer that give rise to dominant distortions in the output signal. The model should be physically interpretable and verifiable against measurements and other numerical simulations, such as the finite element method.

The method is also intended to improve measurement and diagnostic evaluation of the transducer, identify the critical causes of distortion, and establish relationships with the transducer's geometry and material properties.

The method is also intended to provide the theoretical basis for developing digital algorithms for distortion compensation and control, which can be implemented on low-cost processors with minimal effort (in terms of memory requirements and computational power).

The method is intended to minimize the number of free model parameters to facilitate their identification and to improve the robustness of adaptive parameter tracking in the presence of time-variant properties and production-related variances.

### SUMMARY OF THE INVENTION

According to the inventive idea, this goal is achieved in the first step of the method by modal decomposing the magnetic flux distribution into partial fluxes, Φₘ. These so-called modal fluxes Φₘ flow on stationary paths and have a fixed connection to the immovable components of the transducer, which consist, for example, of iron, permanent magnet material, a stationary coil, air, short-circuit rings, or other conductive material that are used for the deliberate generation of induced currents at certain positions.

Based on this modal decomposition, the transducer can be described with a block-oriented system model, in which static nonlinearities without memory are separated from linear dynamical systems with memory.

The method calculates each modal flux Φₘ with the help of a modal magnetomotive force Fₘ and a modal reluctance Rₘ of the stationary material through which the modal flux flows.

A first modal nonlinearity N_{F,m}(x) describes the coupling between the magnetomotive force Fₘ and a modal excitation current iₘ, where i_{C} represents a coil current or an equivalent magnetization current i_{M} of a magnet. If the modal excitation current flows in the moving drive element, then the first nonlinearity N_{F,m}(x), is a function of the displacement x. If the modal excitation current iₘ flows in at a fixed position, then the nonlinearity degenerates to a constant value N_{F,m}(x)=const. Thus, the first modal nonlinearity N_{F,m}(x) is a static nonlinear system with no memory, dynamics, or frequency dependence.

The method models the modal reluctance Rₘ using a magnetic network with lumped elements that describe the linear and nonlinear properties of the different materials penetrated by the modal flux Φₘ. A modal reluctance function Rₘ(jω) summarizes the effect of the linear lumped elements and behaves like a linear, time-invariant, dynamical system with memory and frequency dependence. A modal flux source summarizes the impact of the nonlinear lumped elements. It generates the total nonlinear distortions Φ_{N,m} caused by nonlinear material properties of the iron (e.g., saturation and hysteresis).

The method determines these total nonlinear distortions by performing an additional modal decomposition of each flux Φₘ into further modal subfluxes Φ_{m,i}, each with a different modal permeability μ_{m,i}(t) in the iron. Thus, the index m indicates modal fluxes with the same dependence on the displacement x, and the index i represents a modal subflux that finds a different permeability μ_{m,i}(t) in the iron region through which they flow.

A feature of the invention is that the method determines a modal total field strength H_{T,m,i} for the iron region through which the subflux Φ_{m,i} flows. The modal total field strength H_{T,m,i} takes into account not only the modal field strength H_{m,i} which produces the subflux Φ_{m,i}, but also all other modal field strengths H_{n,k} with m≠n and i≠k, which vary the permeability μ_{m,i}(t) of this iron region due to saturation, hysteresis and other nonlinear material properties.

The method describes this nonlinear coupling of the modal subfluxes in the calculation of the modal total field strength H_{T,m,i} with the help of a parallel coupling factor C_{P,m,i,n,k} and an orthogonal coupling factor C_{O,m,i,n,k}, which take into account the vectorial direction and the distribution density of the modal field strength components at all points in the iron region. This local information about the magnetic field in the iron region is time-invariant and therefore determined once via numerical finite-element simulations. The energetic superposition of orthogonal field strength components results in a rectification and produces nonlinear distortions in the modal total field strength H_{T,m,i}.

Based on the modal total field strength H_{T,m,i}, the modal total field density B_{m,i} is determined using a nonlinear material model that takes into account the saturation and hysteresis in the iron. From this, the instantaneous modal permeability u_{m,i}(t) of the iron is determined for each subflux Φ_{m,i}.

A further characteristic of the invention is the determination of a linked modal flux λₘ by multiplying each modal flux Φₘ by the output of a second modal nonlinearity N_{λ,m}(x). This nonlinearity N_{λ,m}(x) is generally also a memoryless function of the displacement x. Only in the case of a stationary coil does the nonlinearity degenerate to a constant value N_{λ,m}(x)=const., since the coupling between the stationary coil and the stationary flux lines of the modal fluxes does not change. By deriving the sum of all linked modal fluxes λₘ over time, the induction voltage u_{I} is determined, which is a component of the electrical terminal voltage u_{C}.

The method calculates the mechanical force Fₓ acting on the moving drive element from the modal subflux Φₘ. The calculation is performed along an air path around the mechanical drive element, analogous to the Maxwell Stress Tensor method. This method accounts for losses arising from iron-induced currents or hysteresis and can be applied to transducers for which the virtual work method fails.

A feature of the invention is that the modal model can be adapted to a specific transducer type, thereby simplifying the structure and reducing the number of free model parameters. Even the selection of the drive element, i.e., whether a voice coil, a magnet, or an armature is chosen, opens up possibilities for simplification. For this purpose, it is helpful to divide the modal fluxes into modal coil fluxes Φ_{C,m}, and modal magnet fluxes Φ_{M,m}.

The number M_{T} of the necessary modal fluxes Φₘ and their modal parameters (e.g., N_{λ,m}(x), N_{F,m}(x), and Rₘ(jω)) can be determined by formal mathematical methods, such as singular value decomposition (SVD) and non-negative matrix factorization. Here, the SVD can be applied to the linked flux λ(jω, x), simulated with the FEM or electrically measured via the induction voltage to determine the modal reluctance function Rₘ(jω) as well as the displacement-dependent modal nonlinearities N_{F,m}(x) and N_{λ,m}(x). The optimal number M_{T} of modal subfluxes is determined by the drop in singular values or modeling error.

The modal vector flux density Bₘ(r, jωₙ, xₖ) can be determined by using the modal reluctance function Rₘ(jω), the first displacement-dependent nonlinearities N_{F,m}(x) of the dominant modes, the vectorial total flux density B(r, jωₙ, xₖ), which is calculated using the finite element method (FEM) at the observation points r, frequency ωₙ, and displacement xₖ. They are highly diagnostic for interpreting magnetic modes and their relationships with geometry and material parameters.

The modal model with identified parameters is used to calculate the transducer output signal, typically the displacement x, the driving force Fₓ, the induction voltage u_{I}, or any other derived quantity. The signal distortions are separated from the desired (linear) output, analyzed, and evaluated for their impact on it. Here, the dominant nonlinearities and other critical linear properties of the reluctance function Rₘ(jω) are identified, enabling design improvements.

The transformation of nonlinear distortions into equivalent input distortions underpins the active compensation of these distortions using an electrical control system.

### SHORT DESCRIPTION OF THE DRAWINGS

FIG. 1 shows a schematic representation of the modal fluxes generated by a coil current in an electrodynamic loudspeaker at different displacements of the voice coil.

FIG. 2 shows a schematic representation of the modal flux generated by a magnet in an electrodynamic loudspeaker at different displacements of the voice coil.

FIG. 3 shows a schematic representation of the modal flux generated by the coil current in a loudspeaker with a moving magnet at different displacements.

FIG. 4 shows a schematic representation of the modal fluxes generated by the magnet in a loudspeaker with a moving magnet at different displacements.

FIG. 5 shows a schematic representation of the modal fluxes generated by the coil current in a hearing aid transducer with a moving armature at different displacements.

FIG. 6 shows a schematic representation of the modal fluxes generated by the magnets in a hearing aid transducer with a moving armature at different displacements.

FIG. 7 shows a block diagram of the main steps of the invention.

FIG. 8 shows a generalized system model of the electromechanical transducer as the basis for the process.

FIG. 9 shows a block diagram of the process steps for identifying modal parameters using nonnegative matrix factorization.

FIG. 10 shows a magnetic network with lumped parameters used to model the modal fluxes generated by the magnetomotive force Fₘ.

FIG. 11 shows a block diagram of the process steps used to determine the nonlinear distortions generated in the iron material.

FIG. 12 shows a block diagram of further procedural steps for determining the total modal field strength H_{T,m,i}(t).

### DETAILED DESCRIPTION OF THE INVENTION

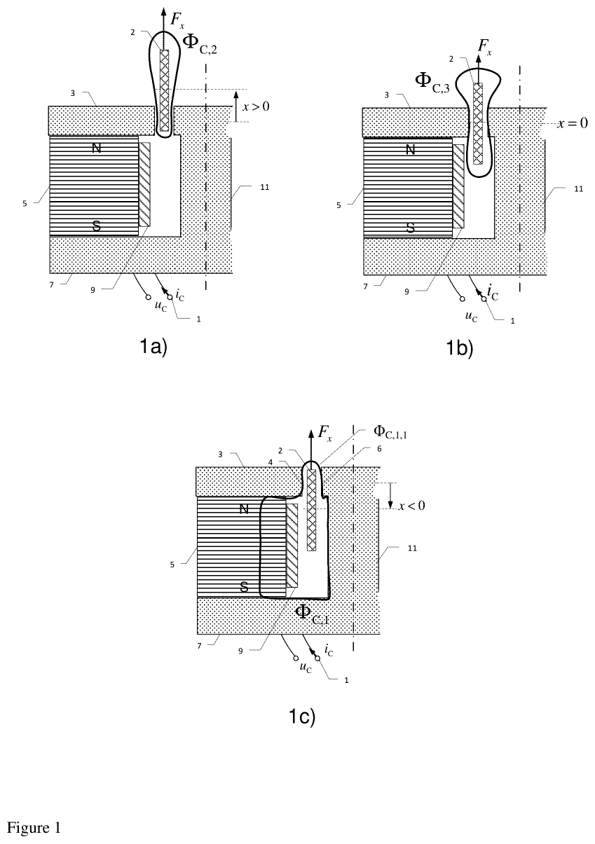

FIG. 1 shows cross-sectional diagrams of an electrodynamic transducer, consisting of a voice coil 2 in an air gap with the electrical input terminals 1, a permanent magnet 5, a short-circuit ring 9, and other iron components (pole plate 3, pole core 11, and back plate 7) that close the magnetic circuit. The cross-sectional images 1a, 1b, and 1c show the voice coil in different positions. The magnetic field generated by the coil current i_{C} is schematically represented by characteristic field lines for the various displacements. According to the invention, these changes in the coil field can be explained by the modal coil fluxes Φ_{C,m} for m=1, 2, 3.

The first modal coil flux Φ_{C,1} is dominant at low frequencies and negative displacements x<0 (FIG. 1c). It flows through the air gap and the magnet, along the surface of the iron components, due to the skin effect. The induced current in the short-circuit ring 9 reduces and linearizes the displacement-dependent inductance of the voice coil.

At the voice coil rest position x=0 and at medium frequencies (FIG. 1b), the second modal coil flux Φ_{C,2} becomes dominant, flowing only over the pole faces and through the air around the voice coil. Here, the influence of the short-circuit ring and the skin effect is reduced.

For x>0 and at high frequencies (FIG. 1a), the third modal coil flux Φ_{C,3} becomes dominant, which flows through the air around the voice coil. Here, the influence of the short-circuit ring and the skin effect is negligible.

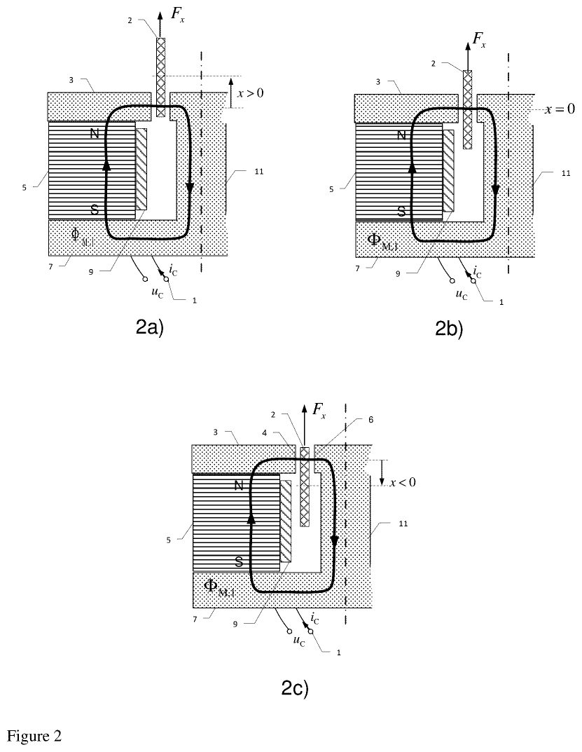

FIG. 2 shows the field generated by magnet 5 at different voice-coil displacements for the same transducer as in FIG. 1. The characteristic field line hardly changes with the voice coil displacement and can be described by a modal magnet flux Φ_{M,1}. This has a similar course to the first coil flux Φ_{C,1}, but uses the entire cross-section of the iron component. The skin effect and the short-circuit ring 9 are inactive because no current is induced in the iron.

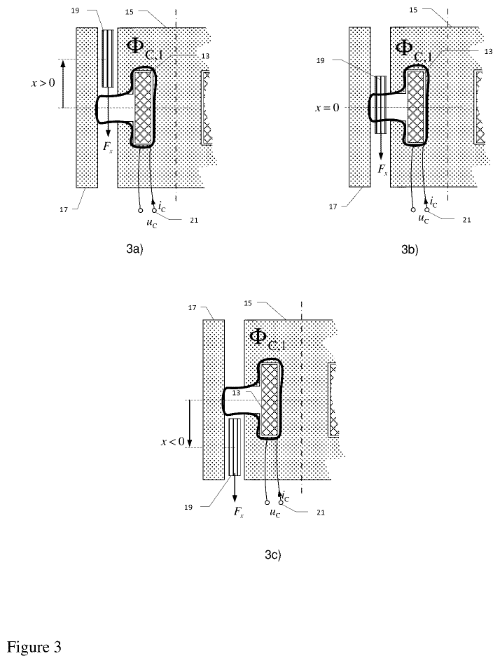

FIG. 3 shows cross-sectional images of an electromechanical transducer, consisting of a moving magnet 19 in an air gap, a stationary coil 13 with the electrical input terminals 21, and other iron components (pole plate 17, pole core 15) that close the magnetic circuit. The cross-sectional FIGS. 3a, 3b, and 3c show the characteristic field line of the magnetic field generated by the coil current i_{C} at different displacements of the magnet, which can be explained by a common modal coil flux Φ_{C,1}. The induced currents in the conductive iron material push the flux to the surface, resulting in lossy inductance.

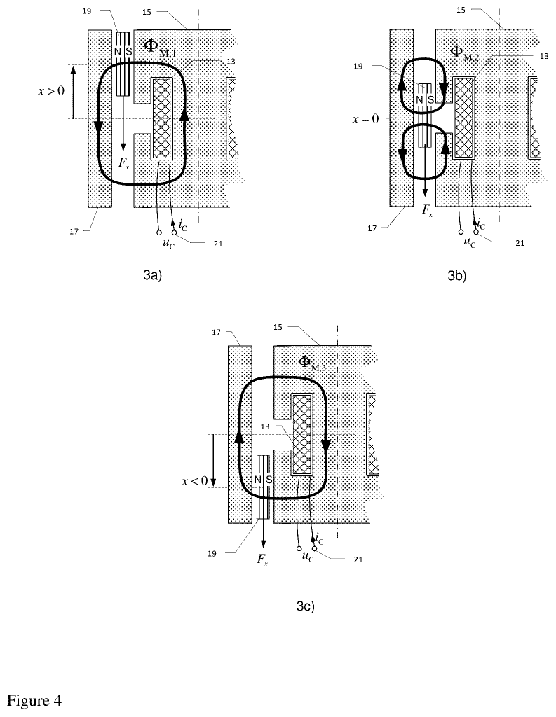

FIG. 4 shows the influence of the displacement x on the characteristic field line of the flux generated by the magnet for the same transducer as FIG. 3. For x>0, a first modal magnet flux Φ_{M,1} is created through the entire cross-section of the iron material and the air gap (FIG. 3a). If the magnet is at rest position x=0, a second modal magnet flux Φ_{M,2} is created, which flows symmetrically through the upper and lower iron components and the air gap (FIG. 3b). For x<0, a third modal magnet flux Φ_{M,3} is created, which is similar to the first modal magnet flux Φ_{M,}1, in a symmetrical structure, but flows in the opposite direction (FIG. 3c).

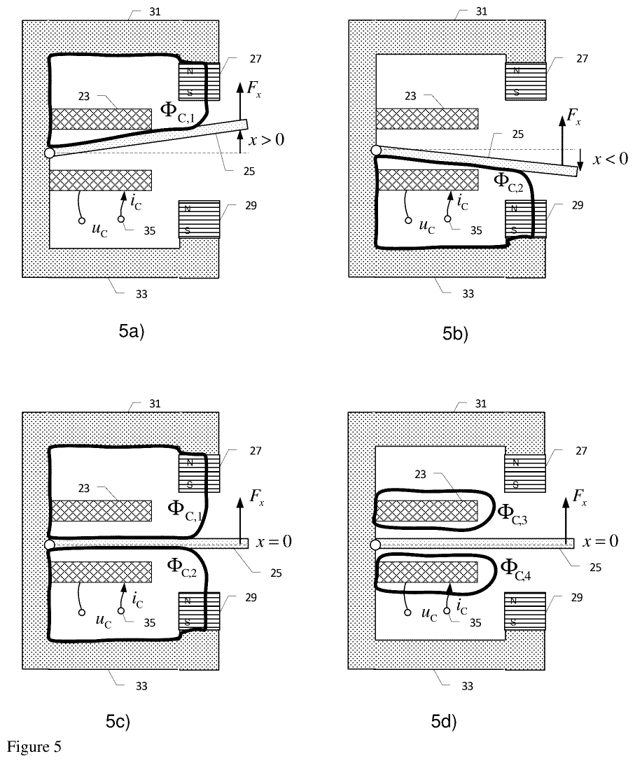

FIG. 5 shows cross-sectional images of a balanced-armature-transducer with a moving armature 25 in an air gap, a stationary coil 23 with input terminals 35, two stationary permanent magnets 27 and 29, and conductive iron components 31 and 33 that close the magnetic circuit. The cross-sectional FIGS. 5a, 5b, and 5c show the characteristic magnetic field line generated by the coil current i_{C} at low audio frequencies and at different displacements x of the armature 25. The change in this field line can be explained by two modal subfluxes, Φ_{C,1} and Φ_{C,2}, where Φ_{C,1} flows through magnet 27 and Φ_{C,2} through magnet 29. In the electrically conductive iron, the two subfluxes, Φ_{C,1} and Φ_{C,2}, are pushed to the surface. The cross-sectional image 5d shows additional modal subfluxes Φ_{C,3} and Φ_{C,4}, which become dominant at high audio frequencies at the rest position x=0 and are determined by the air reluctance.

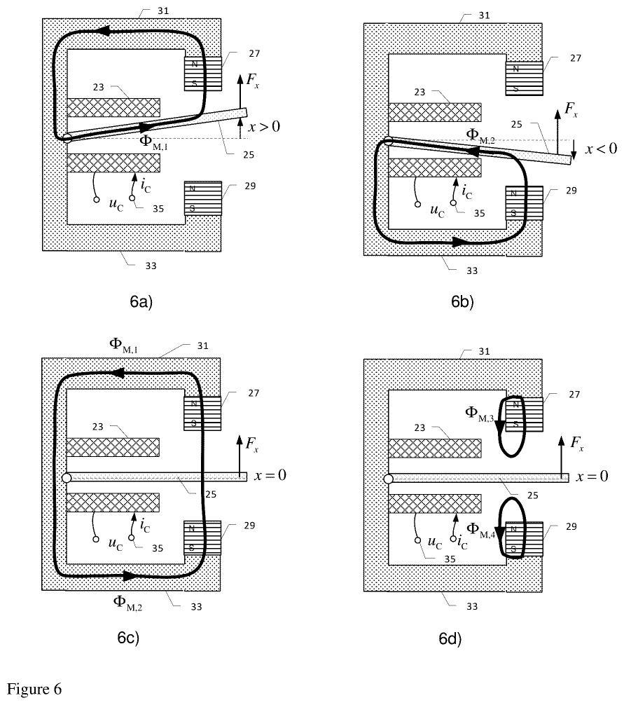

FIG. 6 shows the influence of the displacement x on the magnet fluxes generated by magnets 27 and 29 for the same transducer as FIG. 5. For x>0, a first modal magnet flux Φ_{M,1} is created, which flows through the entire cross-section of the armature 25, the upper air gap, the magnet 27, and the iron material 31 (FIG. 6a). For x<0, a second modal magnet flux Φ_{M,2} is created, which flows through the entire cross-section of the armature 25, the lower air gap, the magnet 29, and the iron material 31 (FIG. 6b). If the armature 25 is at the geometric symmetry point at x=0, then the two modal magnet fluxes Φ_{M,1} and Φ_{M,2} in the armature 25 compensate each other, and the magnet fluxes in the outer iron region 31 and 33 are strengthened (FIG. 6c). FIG. 6d presents the additional modal magnet fluxes, Φ_{M,3} and Φ_{M,4}, which are particularly important in the resting position x=0 and are governed by air reluctance.

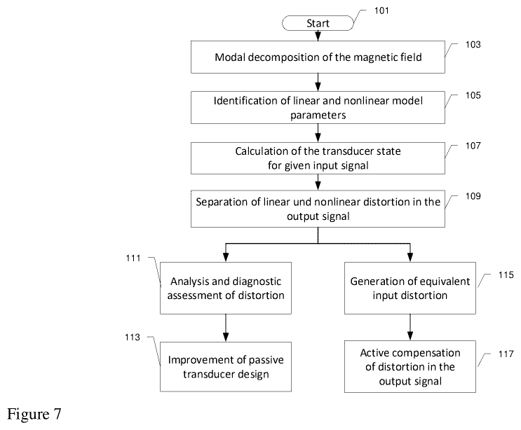

FIG. 7 shows the essential process steps of the invention in a generalized block diagram. The procedure starts 101 with modal decomposition 103 of the magnetic field in the transducer. In step 104, the model's linear and nonlinear parameters are determined from measurements or simulations. The model and the concrete transducer parameters form the basis for step 107 of the following method, in which the modal flux Φₘ and other transducer state variables are determined for a given input signal. In step 109, the linear and nonlinear distortions in the acoustic output signal are determined from the calculated modal fluxes Φₘ. These distortions in the output signal are analyzed and evaluated for diagnostic purposes in step 111, and the transducer is improved in step 113 through design modifications. Alternatively, in step 115, equivalent input distortions can be determined from the output signal distortion, thereby enabling active compensation of these distortions in step 117.

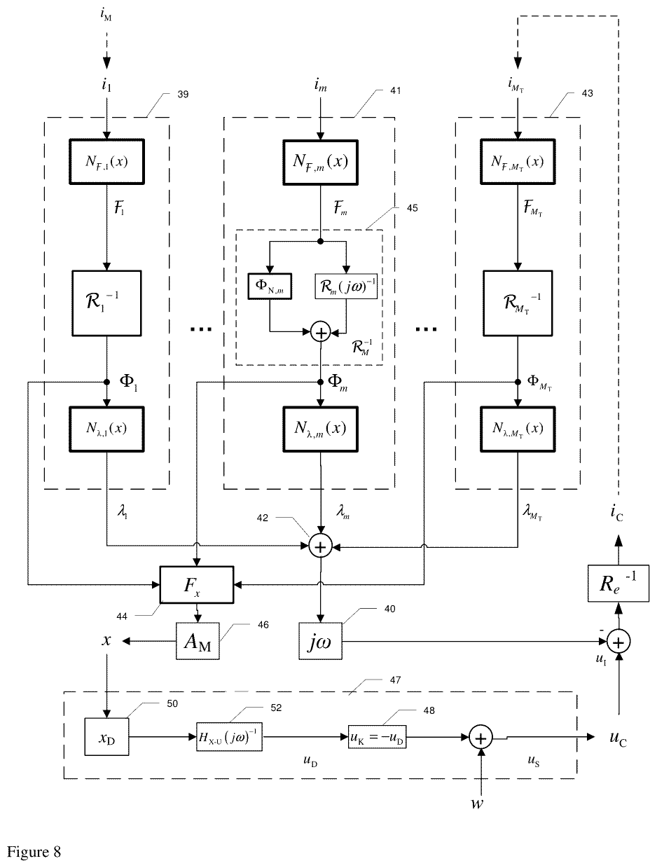

FIG. 8 presents a generalized system model of the electromechanical transducer, which underpins the process. In the first step of the method, the magnetic flux distribution in the transducer is modeled as the sum of modal fluxes Φₘ with m=1, . . . , M_{T}:

$$Φ = {\sum }_{m = 1}^{{M}_{T}} {Φ}_{m}$$

The number of M_{T} for these fluxes is adjusted to account for the transducer's specific properties during modeling.

Each modal flux Φₘ is determined by means of a modal magnetomotive force Fₘ (flux) and a modal reluctance Rₘ in the second step:

$${Φ}_{m} = {f}_{{R}_{m}} ( {\text{?}}_{m} ) = {\text{?}}_{m} ( t ) * {F}^{- 1} \{ \frac{1}{{ℛ}_{m} ( j ω )} \} + {Φ}_{N , m} ( t )$$

The modal reluctance Rₘ can be approximated in the small-signal region by a linear modal reluctance function Rₘ(jω), which is used to calculate the linear fraction of the modal flux in the time domain with the help of the inverse Fourier transform F⁻¹ and the convolution operator *. Block 45 contains an additional nonlinear flux source Φ_{N,m}, which represents the signal distortions caused by hysteresis and other nonlinear iron properties.

The magnetomotive force Fₘ is described by means of a first modal nonlinearity N_{F,m}(x), and a generalized modal excitation current iₘ:

$${\text{?}}_{m} ( t ) = {N}_{F , m} ( x ) {i}_{m}$$

The first modal nonlinearity N_{F,m}(x), is a static, i.e., memoryless function of the displacement x. The modal excitation current iₘ represents the coil current i_{C} or an equivalent magnetizing current iₘ of a magnet.

In a further step, the linked flux λₘ concatenated with the coil is generated by m=1, . . . , M_{T} by multiplying the modal flux Φₘ by a second modal nonlinearity N_{λ,m}(x):

$${λ}_{m} ( t ) = {Φ}_{m} ( t ) {N}_{λ , m} ( x )$$

The modal blocks 39, 41, and 43 are dynamic, nonlinear systems in which memory is lumped in the modal reluctances Rₘ, which are displacement-independent and embedded between two displacement-dependent, memoryless nonlinearities N_{F,m}(x) and N_{λ,m}(x).

In the next step, the induction voltage u_{I} is formed by time differentiation 40 of the sum 42 of all linked modal fluxes λ_{C,m} with m=1, . . . , M_{T}:

$${u}_{I} ( t ) = {\sum }_{m = 1}^{{M}_{T}} \frac{d {λ}_{m}}{d t} = {\sum }_{m = 1}^{{M}_{T}} {λ}_{m} ( t ) * {F}^{- 1} \{ j ω \}$$

The difference between the transducer terminal voltage u_{C} and the induction voltage u_{I} divided by the DC resistance Rₑ yields the coil current i_{C}, which produces at least one magnetomotive force Fₘ.

$${i}_{C} = \frac{{u}_{C} - {u}_{I}}{{R}_{e}}$$

In a further step of the method, the mechanical force Fₓ is calculated with the help of the modal fluxes Φₘ with m=1, . . . , M_{T}:

$${F}_{x} ( t ) = \frac{1}{2} \frac{d}{d x} {( {\sum }_{m = 1}^{{M}_{T}} {c}_{F , m} {Φ}_{m} )}^{2}$$

This calculation 44 uses the property of modal fluxes that, with the displacement x, only the strength of the modal fluxes Φₘ, changes, not their local distribution in the modal flux density field Bₘ(r). The coefficients C_{F,m} take into account the displacement-independent coupling of the modal flux to a stationary envelope area in the air around the mechanical drive element, as well as the constant permeability of the air. These coefficients C_{F,m} can be determined once for a given transducer using the related Maxwell Stress Tensor method, the Laplace force, and other calculation methods. Although the virtual work method does not account for the effects of eddy-current and hysteresis losses in iron in the direct calculation of forces in magnetic systems, these (frequency-independent) coefficients C_{F,m} can also be determined with this method at sufficiently low frequencies, where the losses are negligible.

In a further step 46, the displacement x of the drive element is determined with the help of the mechanical force Fₓ and a mechanical load admittance A_{M}, which is fed back to all displacement-dependent nonlinearities N_{F,m}(x) and N_{λ,m}(x).

The free parameters introduced by modal modeling, in particular the modal reluctance Rₘ, the first modal nonlinearity N_{F,m}(x) with m=1, . . . , M_{T} and the second modal nonlinearity N_{λ,m}(x) are determined in a further step of the method based on externally measurable state signals, such as electrical terminal voltage u_{C}, input current i_{C}, mechanical displacement x or driving force Fₓ and numerically simulated modal fluxes Φₘ. For adaptive parameter identification during the transmission of any input signal, such as an ordinary audio signal, sensing the electrical input current i_{C} is suitable.

Based on model parameters identified using measurement technology, the transducer's dynamic behavior during signal transmission is subsequently analyzed. The linear and nonlinear distortions are separated, and the dominant physical causes of signal distortion are identified. This detailed information enables targeted design improvements to the transducer, particularly for component geometry and material selection.

Active compensation of linear and nonlinear signal distortions in 47 is a further process step that does not require any modification of the transducer and leverages the growing capabilities of electrical control and digital signal processing 48. In this case, block 50 separates the signal distortions x_{D} in the output signal (e.g., in displacement x). Block 5 transforms the signal distortion x_{D} into equivalent electrical input distortion up with the help of the inverse linear transfer function H_{X-U}(jω)⁻¹. Control block 48 synthesizes compensation distortions u_{K} from the undistorted input signal w that correspond to the negated equivalent input distortions. These are added to the input signal w and supplied as a control signal u_{S} to the transducer input, which is the terminal voltage u_{C}.

The physical interpretation of the state variables and other parameters can be improved for diagnostic purposes if the coil current i_{C} and an equivalent magnetizing current iₘ replace the generalized modal currents iₘ. Then two groups of partial fluxes are formed, in which the modal coil fluxes Φ_{C,m} with m=1, . . . , M_{C} are separated from the modal magnet fluxes Φ_{M,m} with m=1, . . . , M_{M}:

$$Φ = {\sum }_{m = 1}^{{M}_{C}} {Φ}_{C , m} + {\sum }_{m = 1}^{{M}_{M}} {Φ}_{M , m}$$

$${Φ}_{C , m} ( t ) = {F}^{- 1} \{ \frac{1}{{R}_{C , m} ( j ω )} \} * {F}_{C , m} ( t ) + {Φ}_{N - {C}_{m}} ( t )$$

$${\text{?}}_{C , m} ( t ) = {N}_{ℱ - C , m} ( x ) {i}_{C} ( t )$$

$${λ}_{C , m} ( t ) = {Φ}_{C , m} ( t ) {N}_{λ - C , m} ( x )$$

$${Φ}_{M , m} ( t ) = {F}^{- 1} \{ \frac{1}{{ℛ}_{M , m} ( j ω )} \} * {\text{?}}_{M , m} ( t ) + {Φ}_{N - M , m} ( t )$$

$${\text{?}}_{M , m} ( t ) = {N}_{ℱ - M , m} ( x ) {i}_{M}$$

$${λ}_{M , m} ( t ) = {Φ}_{M , m} ( t ) {N}_{λ - M , m} ( x )$$

$${U}_{I} ( t ) = {\sum }_{m = 1}^{{M}_{C}} \frac{d {λ}_{C , m}}{d t} + {\sum }_{m = 1}^{{M}_{M}} \frac{d {λ}_{M , m}}{d t}$$

This separation is beneficial for the interpretation of the components in the mechanical force Fₓ:

$$\begin{matrix}{F}_{x} ( t ) = \frac{1}{2} \frac{d}{dx} {( {\sum }_{m = 1}^{{M}_{M}} {c}_{M , m} {Φ}_{M , m} + {\sum }_{m = 1}^{{M}_{C}} {c}_{C , m} {Φ}_{C , m} )}^{2} \\ = ( {\sum }_{m = 1}^{{M}_{M}} {c}_{M , m} {Φ}_{M , m} ) {\sum }_{m = 1}^{{M}_{M}} {c}_{M , m} \frac{d {Φ}_{M , m}}{d x} + ( {\sum }_{m = 1}^{{M}_{M}} {c}_{M , m} {Φ}_{M , m} ) {\sum }_{m = 1}^{{M}_{C}} {c}_{C , m} \frac{d {Φ}_{C , m}}{dx} + ( {\sum }_{m = 1}^{{M}_{c}} {c}_{M , m} {Φ}_{C , m} ) {\sum }_{m = 1}^{{M}_{M}} {c}_{M , m} \frac{d {Φ}_{M , m}}{dx} + ( {\sum }_{m = 1}^{{M}_{c}} {c}_{C , m} {Φ}_{C , m} ) {\sum }_{m = 1}^{{M}_{C}} {c}_{C , m} \frac{d {Φ}_{C , m}}{dx} \\ = {F}_{MM} + {F}_{MC} + {F}_{CC}\end{matrix}$$

The partial force F_{MM} is generated exclusively by combinations of the modal magnet fluxes Φ_{M,m} with each other. This force is independent of the coil current i_{C} as far as the iron material behaves linearly. The ratio of the partial force F_{MM} to the displacement x corresponds to the nonlinear magnetic spring stiffness. In some applications, this force is compensated by other external forces that hold the magnet stationary.

Multiplicative couplings between the modal coil fluxes Φ_{C,m} and the modal magnet fluxes Φ_{M,m} generate the partial force F_{MC}. This force can contain a useful linear force component if the local derivative of a modal flux in a working area is nearly constant. This effect, for example, generates the Laplace force due to the Bl product in an electrodynamic transducer with a voice coil.

The partial force F_{CC} is generated exclusively by combinations of the modal coil fluxes Φ_{C,m} with each other. This force is independent of the magnetizing current i_{M}, as long as the iron material behaves linearly. It can be interpreted as a reluctance force proportional to the square of the input current, i_{C}. The resulting nonlinear signal distortions can be avoided by using a stationary coil, or they can be suppressed by reducing the displacement dependence of the coil fluxes Φ_{C,m}.

For the transducers shown in FIGS. 1-6, the complexity of the physical modelling can be reduced, and the number of process steps can be reduced.

In a transducer with a moving voice coil and a magnet at a fixed position, according to FIGS. 1 and 2, the modal model can be significantly simplified, and only one modal magnet flux Φ_{M,1} needs to be considered:

$$Φ = {\sum }_{m = 1}^{{M}_{C}} {Φ}_{C , m} + {Φ}_{M , 1}$$

The first and second modal nonlinearity are identical for the coil fluxes Φ_{C,m}, and correspond to the effective modal number of turns N_{C,m}(x) of the voice coil:

$$\text{?} ( x ) = {N}_{λ , C , m} ( x ) = {N}_{C , m} ( x )$$

The first modal nonlinearity of the magnet flux degenerates into a constant, since in the stationary magnet, the excitation conditions do not change with the displacement x:

$$\text{?} ( x ) = const .$$

The second nonlinearity is displacement-dependent, but can be modeled using the effective modal number of turns N_{C,m}(x), and modal linking constants:

$${N}_{λ - M , 1} ( x ) = {\sum }_{m = 1}^{{M}_{C}} {c}_{λ - M , m} {N}_{C , m} ( x )$$

The modal linking constants C_{λ-M,m} capture the geometric congruence between the field distributions of the magnet flux Φ_{M,1} and the modal coil fluxes Φ_{C,m}.
If the saturation and hysteresis in the iron are neglected, the magnet flux Φ_{M,1} is independent of the displacement x:

$$\frac{d {Φ}_{M , 1}}{d x} \approx 0$$

As a result, the total mechanical force Fₓ for the voice coil contains only two partial forces:

$$\begin{matrix}{F}_{x} ( t ) = \frac{1}{2} \frac{d}{dx} {( {\sum }_{m = 1}^{{M}_{C}} {c}_{C , m} {Φ}_{C , m} + {c}_{M , 1} {Φ}_{M , 1} )}^{2} \\ = {c}_{M , 1} {Φ}_{M , 1} {\sum }_{m = 1}^{{M}_{C}} {c}_{C , m} \frac{d {Φ}_{C , m}}{d x} + ( {\sum }_{m = 1}^{{M}_{C}} {c}_{C , m} {Φ}_{C , m} ) {\sum }_{m = 1}^{{M}_{C}} {c}_{C , m} \frac{d {Φ}_{C , m}}{d x} \\ = {F}_{M C} + {F}_{C C}\end{matrix}$$

The first partial force F_{MC} arises from the mutual interaction between magnet fluxes Φ_{M,1} and coil flux Φ_{C,m}, and alternatively can be calculated by the Laplace force F_{MC}=Bl(x)i_{C}. The second partial force F_{CC} arises solely from interactions among modal coil fluxes, and can be interpreted as a reluctance force.

In a transducer with a moving magnet and a stationary coil, according to FIGS. 3 and 4, the magnetic field generated by the coil current i_{C} can be represented by one modal coil flux Φ_{C,1}:

$$Φ = {Φ}_{C , 1} + {\sum }_{m = 1}^{{M}_{M}} {Φ}_{M , m}$$

The first and second modal nonlinearity of the coil flux Φ_{C,1} degenerate to a common constant N_{C}, which corresponds to the constant number of turns N_{C} of the stationary coil:

$$\text{?} ( x ) = {N}_{λ - C , m} ( x ) = {N}_{C}$$

The first modal nonlinearity N_{F-M,m}(x) of the magnet flux Φ_{M,m} is the only displacement-dependent nonlinearity in this transducer. The second modal nonlinearity degenerates to a constant value:

$${N}_{λ - M , m} ( x ) = {c}_{λ - M , m} {N}_{C}$$

The modal linking constant C_{λ-M,m} captures the geometric congruence between the field distributions of the coil flux Φ_{C,1} and the modal magnet fluxes Φ_{M,m}.

If the saturation and hysteresis in the iron are neglected, the coil flux is thus independent of the displacement x:

$$\frac{d {Φ}_{C , 1}}{dx} \approx 0$$

The total mechanical force Fₓ also contains two partial forces:

$$\begin{matrix}{F}_{x} ( t ) = \frac{1}{2} \frac{d}{d x} {( {\sum }_{m = 1}^{{M}_{M}} {c}_{M , m} {Φ}_{M , m} + {c}_{C , 1} {Φ}_{C , 1} )}^{2} \\ = ( {\sum }_{m = 1}^{{M}_{M}} {c}_{M , m} {Φ}_{M , m} ) {\sum }_{m = 1}^{{M}_{M}} {c}_{M , m} \frac{d {Φ}_{M , m}}{d x} + {c}_{C , 1} {Φ}_{C , 1} {\sum }_{m = 1}^{{M}_{M}} {c}_{M , m} \frac{d {Φ}_{M , m}}{d x} \\ = {F}_{MM} + {F}_{MC}\end{matrix}$$

The first partial force F_{MM} arises from interactions of the modal magnet fluxes Φ_{M,m} with itself and can be interpreted as a magnetic spring. The second partial force F_{MC} arises from the interaction between the magnet flux and coil flux. It cannot be calculated for this transducer as a Laplace force with the help of the Bl(x) product, but must be determined by the Maxwell Stress Tensor method.

In a transducer with a movable armature and a stationary coil, according to FIGS. 5 and 6, there are several modal coil fluxes (M_{C}>1) and several modal magnet fluxes (M_{M}>1):

$$Φ = {\sum }_{m = 1}^{{M}_{C}} {Φ}_{C , m} + {\sum }_{m = 1}^{{M}_{M}} {Φ}_{M , m}$$

The first modal nonlinearity of the coil flux and the magnet flux is identical and corresponds to a memoryless air gap nonlinearity R_{A,m}(x), which can be interpreted physically as a displacement-dependent reluctance:

$$\text{?} ( x ) = \text{?} ( x ) = {ℛ}_{A , m} ( x )$$

The magnetomotive force F_{C,m} is determined by means of the coil current i_{C}, the constant number of turns N_{C}, the modal coil flux Φ_{C,m}, and the modal air gap nonlinearity R_{A,m}(x):

$${ℱ}_{C , m} = {N}_{C} {i}_{C} - {Φ}_{C , m} {ℛ}_{A , m} ( x )$$

The magnetomotive force F_{M,m} is also determined by means of the magnetizing current i_{M}, the modal magnet flux Φ_{M,m}, and the modal air-gap nonlinearity R_{A,m}(x):

$$\text{?} = {i}_{M} - {Φ}_{M , m} {ℛ}_{A , m} ( x )$$

The second modal nonlinearity of the coil flux and the magnet flux degenerates to the constant number of turns N_{C} of the coil, since both the coil and the magnets are stationary, and the first two modal fluxes flow through the coil:

$${N}_{λ - M , m} ( x ) = {N}_{λ - C , m} ( x ) = {N}_{C}$$

The total mechanical force Fₓ consists of three partial forces, as in the general case:

$$\begin{matrix}{F}_{x} ( t ) = \frac{1}{2} \frac{d}{d x} {( {\sum }_{m = 1}^{{M}_{M}} {c}_{M , m} {Φ}_{M , m} + {\sum }_{m = 1}^{{M}_{C}} {c}_{C , m} {Φ}_{C , m} )}^{2} \\ = {F}_{MM} + {F}_{MC} + {F}_{CC}\end{matrix}$$

The first partial force F_{MM} arises from interactions among modal magnet fluxes and can be interpreted as a magnetic spring. The second partial force F_{MC} is caused by the interaction between magnet and coil flux and cannot be calculated as a Laplace force with the help of the Bl(x) product, but must be calculated with the Maxwell Stress Tensor method. The third partial force F_{CC} arises from interactions among the modal coil fluxes and is often referred to as the electromagnetic attraction (reluctance) force.

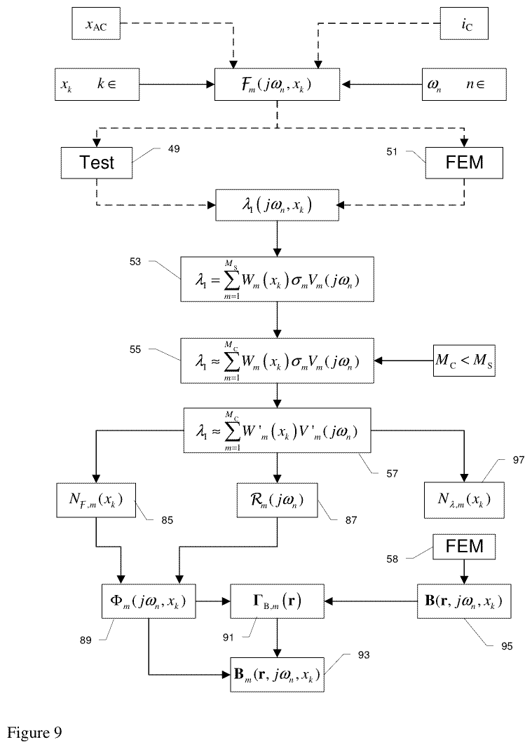

FIG. 9 shows a block diagram of the procedural steps for determining the free parameters introduced by modal modeling. First, the drive element is positioned at defined operating points xₖ with k=1, . . . , K. Afterwards, a time-varying magnetomotive force Fₘ(xₖ, Φₙ) is calculated with the help of the alternating current i_{C} in the coil or an alternating displacement x_{AC} of the drive element at the frequencies ωₙ with n=1, . . . , N at the operating points xₖ of the drive element. Then the total linked flux λ_{I}(jωₙ, xₖ) seen by the coil is determined from the electrical terminal signals of the transducer with the help of measurements 49 or numerical simulations 51:

$${λ}_{I} ( j {ω}_{n} , {x}_{k} ) = \frac{1}{j {ω}_{n}} [ {U}_{c} ( j {ω}_{n} , {x}_{k} ) - {I}_{c} ( j {ω}_{n} , {x}_{k} ) {R}_{e} ]$$

$$k = 1 , … , K , n = 1 , … , N$$

In the following steps 53, 55, 57, the total linked flux λ_{I}(jωₙ, xₖ) is decomposed into a product of non-negative matrices, as described for example by Daniel D. Lee and H. Sebastian Seung, “Algorithm for Non-negative Matrix Factorization” in Advances in Neural Information Processing Systems 13 (NIPS 2000). It is helpful in 53 to first decompose the total linked flux λ_{I}(jωₙ, xₖ) into orthogonal modes m=1, . . . , M_{S} by means of a singular value decomposition, where each orthogonal mode is represented by a frequency dependence Vₘ(jωₙ), a displacement dependence Wₘ(xₖ), and a singular value om:

$${λ}_{I} ( j {ω}_{n} , {x}_{k} ) = {\sum }_{m = 1}^{{M}_{S}} {W}_{m} ( {x}_{k} ) {σ}_{m} {V}_{m} ( j {ω}_{n} )$$

In the next step 55, the dominant orthogonal flux modes m=1, . . . , M_{C} are selected with 1≤M_{C}<M_{S}, taking into account the drop of the singular value σₘ, where the dominant orthogonal modes approximate the total linked flux λ_{I}(jωₙ, xₖ):

$${λ}_{I} ( j {ω}_{n} , {x}_{k} ) \approx {\sum }_{m = 1}^{{M}_{c}} {W}_{m} ( {x}_{k} ) {σ}_{m} {V}_{m} ( j {ω}_{n} )$$

In the following step 57, non-negative vectors W′ₘ(xₖ) and V′(jωₙ) are generated from the dominant orthogonal flux modes by iterative estimation, which meet the physical requirements for a modal reluctance function and a modal nonlinearity:

$${λ}_{I} ( j {ω}_{n} , {x}_{k} ) \approx {\sum }_{m = 1}^{{M}_{c}} {W}_{m}^{′} ( {x}_{k} ) {V}_{m}^{′} ( j {ω}_{n} )$$

Afterwards, the modal nonlinearities N_{F,m}(xₖ) and N_{λ,m}(xₖ) are calculated from the displacement dependence W′ₘ(xₖ) in steps 85 and 97. The modal reluctance function Rₘ(jωₙ) is calculated using the frequency dependence V′ₘ(jωn) of the dominant flux modes for m=1, . . . , M_{C} in step 87. The particular transducer properties are taken into account here. For example, for the transducer with a voice coil, the following modal parameters of the coil flux result:

$$\text{?} ( {x}_{k} ) = {N}_{λ - C , m} ( {x}_{k} ) = {N}_{C , m} ( x ) = \sqrt{{W}_{m}^{′} ( {x}_{k} )}$$

$${ℛ}_{C , m} ( j {ω}_{n} ) = \frac{1}{{V}_{m}^{′} ( j {ω}_{n} )}$$

An interpolation between the nodes in frequency ωₙ and displacement xₖ leads to the modal nonlinearities N_{F,m}(x) and N_{λ,m}(x), as well as the reluctance function Rₘ(jω) in the desired working area.

The identification of the first modal nonlinearity N_{F,m}(x), and the reluctance function Rₘ(jω) is the basis for the calculation 89 of the modal fluxes Φₘ for an arbitrary electrical excitation current iₘ:

$${Φ}_{m} ( t ) = {F}^{- 1} \{ {{ℛ}_{m} ( j {ω}_{n} )}^{- 1} \} * ( \text{?} ( {x}_{k} ) {i}_{m} ( t ) )$$

If the dependence of the modal fluxes Φₘ on the frequency and the displacement is known, then the modal flux density Bₘ(r, jωₙ, xₖ) at any point r in the magnetic field can be determined with the help of a modal, vectorial distribution function Γ_{B,m}(r) in step 93:

$${B}_{m} ( r , j {ω}_{n} , {x}_{k} ) = {Γ}_{B , m} ( r ) {Φ}_{m} ( j {ω}_{n} , {x}_{k} )$$

The flux distribution function Γ_{B,m}(r) can be estimated by minimizing the quadratic error in step 91 by means of a numerical simulation (FEM 58), which numerically calculates the total flux density B(r, jωₙ, xₖ) in step 95:

$${Γ}_{B , m} ( r ) = arg {min}_{Γ} {\sum }_{∀ ω} {\sum }_{∀ x} {‖ B ( r , j {ω}_{n} , {x}_{k} ) - {\sum }_{∀ m} {Γ}_{B , m} ( r ) {Φ}_{m} ( j {ω}_{n} , {x}_{k} ) ‖}^{{2}^{}}$$

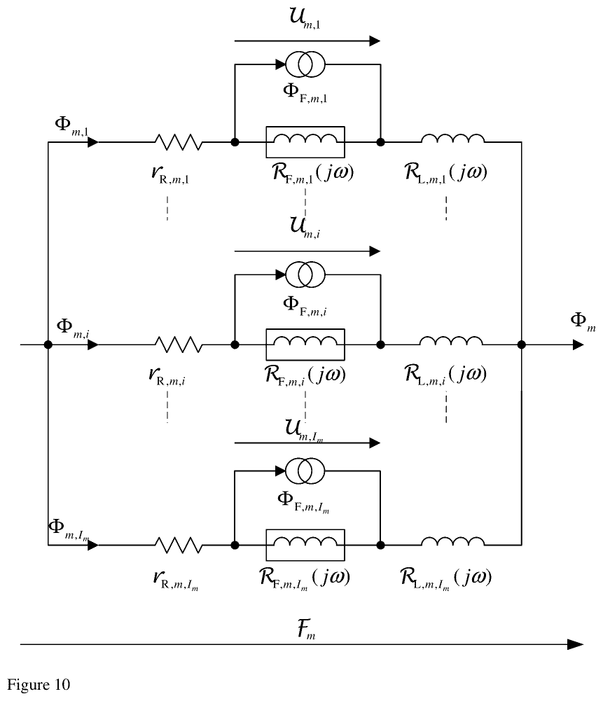

FIG. 10 shows a magnetic network with lumped elements that serves as the basis for determining the modal reluctance R_{m,i}. The network contains in parallel branches, each containing a series circuit of linear elements that describe the reluctance of the materials on a closed field line for a modal subflux Φ_{m,i}:

$$\begin{matrix}{Φ}_{m} = {\sum }_{i = 1}^{{I}_{m}} {Φ}_{m , i} \\ = {\sum }_{i = 1}^{{I}_{m}} ( \text{?} ( t ) * {F}^{- 1} \{ \frac{1}{{ℛ}_{m , i} ( j ω )} \} + {Φ}_{F , m , i} ( t ) * {F}^{- 1} \{ \frac{{ℛ}_{F , m , i} ( j ω )}{{ℛ}_{m , i} ( j ω )} \} )\end{matrix}$$

Each modal subflux Φ_{m,i} comprises a linear and a nonlinear part, where the nonlinear part is generated by the distortion flux Φ_{F,m,i}. The linear fraction can be calculated using a reluctance function R_{m,i}(jω):

$${ℛ}_{m , i} ( j ω ) = \text{?} + {ℛ}_{L , m , i} ( j ω ) + {R}_{F , m , i} ( j ω )$$

The first linear element with a real, frequency-independent, and time-invariant air reluctance r_{R,m,i} represents the magnetic properties of air and magnet.

The second linear element with the ring reluctance function R_{L,m,i}(jω) has an imaginary value and increases proportionally to the frequency ω. This element represents the effect of induced currents in the short-circuit rings 9 in FIGS. 1 and 2, and other conductive material with low permeability:

$${ℛ}_{L , m , i} ( j ω ) \approx j ω \text{?}$$

The third linear element with a complex frequency-dependent iron reluctance function R_{F,m,i}(jω) represents the modal magnet flux in an iron component:

$${ℛ}_{F , m , i} ( j ω ) = \text{?} + \text{?} \sqrt{j ω}$$

The first constant parameter r_{F-L,m,i} describes iron without eddy currents and field displacement, and how laminated iron sheets, ferrites, and other low-conductivity iron materials behave. The second term accounts for induced currents, field displacement, and skin-effect formation and vanishes at very low frequencies. This second term arises from the diffusion equation and is inversely proportional to the adequate penetration depth in iron.

The reluctance function Rₘ(jω) approximates the modal reluctance Rₘ at low flux strength, where the iron material behaves sufficiently linearly:

$$\frac{1}{{ℛ}_{m} ( j ω )} = {\sum }_{i = 1}^{{I}_{m}} \frac{1}{{R}_{m , i} ( j ω )}$$

The network in FIG. 10 shows a magnetic flux source in parallel to the iron reluctance function R_{F,m,i}(jω), which describes the signal distortions Φ_{F,m,i} generated by saturation, hysteresis, and other nonlinear material properties in the iron.

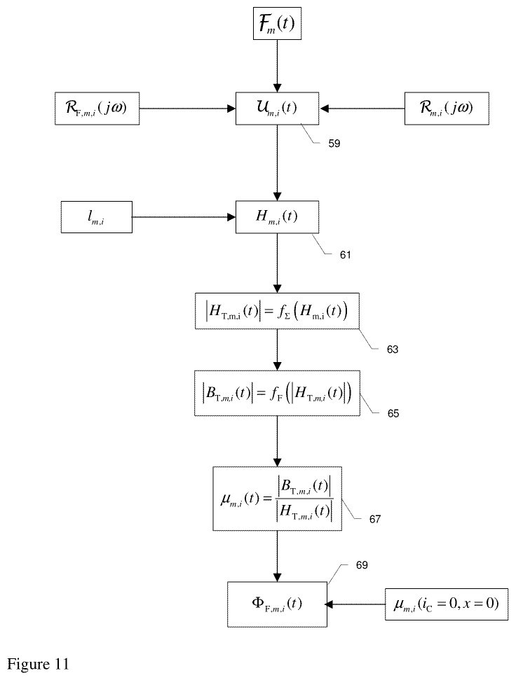

FIG. 11 shows a block diagram of the procedural steps for determining the nonlinear distortions Φ_{F,m,i}. In the first step 59, the modal magnetic voltage U_{m,i}, which is generated by the modal subflux Φ_{m,i} over the iron reluctance function R_{F,m,i}(jω), is determined by means of a linear approximation using the linear elements of the modal network and the modal magnetomotive force Fₘ:

$${𝒰}_{m , i} ( t ) = {ℱ}_{m} ( t ) * {F}^{- 1} \{ \frac{{ℛ}_{F , m , i} ( j ω )}{{ℛ}_{m , i} ( j ω )} \} \qquad ∀ m , ∀ i$$

In the following step 61, at least one modal field strength H_{m,i}(t) is determined, which describes the iron component as an adequate and scalar quantity and can be calculated from the magnetic voltage U_{m,i}, taking into account an effective length l_{m,i} of the iron path:

$${H}_{m , i} ( t ) = \frac{{𝒰}_{m , i} ( t )}{{l}_{m , i}} \qquad ∀ m , ∀ i$$

In the next step 63, the magnitude of a scalar, modal total field strength H_{T,m,i}(t) in the iron component is determined with the help of at least one modal field strength H_{m,i}(t):

$$\vert {H}_{T , m , i} ( t ) \vert = {f}_{Σ} ( {H}_{1 , 1} ( t ) , … , {H}_{m , i} ( t ) , … , {H}_{{M}_{T} , {I}_{m}} ( t ) ) \qquad ∀ m , ∀ i$$

The function ƒ_{Σ} describes the vectorial linking of the modal field strength components in the iron, the integration over the iron volume, and the consideration of nonlinearities that arise from the superposition of orthogonal vector components of the field strength.

In the following step 65, the magnitude of the mean, scalar, modal total flux density |B_{T,m,i}(t)| in the iron component is calculated from the modal total field strength |H_{T,m,i}| based on a material model that describes the nonlinear relationship between field strength and flux density:

$$\vert {B}_{T , m , i} ( t ) \vert = {f}_{F} ( \vert {H}_{T , m , i} ( t ) \vert ) \qquad ∀ m , ∀ i$$

The function ƒ_{F} can exhibit nonlinear behavior and memory, thereby describing saturation and hysteresis in iron. This function can be implemented using well-known hysteresis models, such as the Preisach model; see I. Mayergoyz: Mathematical Models of Hysteresis and their Applications. 2nd edition. Elsevier, 2003, ISBN 978-0-12-480873-7.

In the following step 67, a time-varying, modal permeability μ_{m,i}(t) of the iron component flowing through by the primary subflux Φ_{m,i} is calculated using the modal total field strength H_{T,m,i} and the modal total flux density B_{T,m,i}:

$${μ}_{m , i} ( t ) = \frac{\vert {B}_{T , m , i} ( t ) \vert}{\vert {H}_{T , m , i} ( t ) \vert} \qquad ∀ m , ∀ i$$

In the last step 71, the nonlinear signal distortions Φ_{F,m,i} are calculated using the time-varying modal permeability μ_{m,i}(t), the modal magnetic voltage U_{m,i}, and the iron reluctance function R_{F,m,i}(jω):

$${Φ}_{F , m , i} ( t ) = ( \frac{{μ}_{m , i} ( i ( t ) )}{{μ}_{m , i} ( {i}_{C} = 0 , x = 0 )} - 1 ) {𝒰}_{m , i} ( t ) * {F}^{- 1} \{ \frac{1}{{ℛ}_{F , m , i} ( j ω )} \} \text{?} > \text{?} \sqrt{j ω}$$

$${Φ}_{F , m , i} ( t ) \approx ( \sqrt{\frac{{μ}_{m , i} ( i ( t ) )}{{μ}_{m , i} ( {i}_{C} = 0 , x = 0 )}} - 1 ) {𝒰}_{m , i} ( t ) * {F}^{- 1} \{ \frac{1}{{ℛ}_{F , m , i} ( j ω )} \} \text{?} < \text{?} \sqrt{j ω}$$

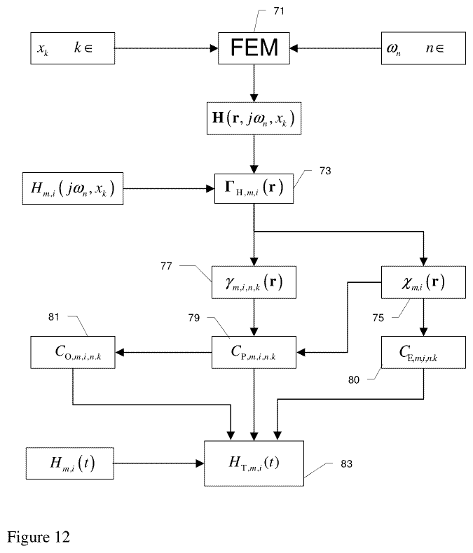

FIG. 12 shows a block diagram of additional procedural steps for determining the total modal field strength H_{T,m,i} (t). A numerical simulation 71 (FEM) first generates the total vectorial field strength H(r, jωₙ, xₖ) as a function of position r in the iron component, the frequency ωₙ, and the displacement xₖ for a transducer with given geometry and defined material properties.

In the following step 73, a modal, vectorial distribution parameter Γ_{H,m,i}(r) is obtained by minimizing the quadratic error between the numerically simulated total field strength H(r, jωₙ, xₖ) and a modal development of the total field strength using the effective modal field strength H_{m,i}(jω, x) and the distribution parameter Γ_{H,m,i}(r) estimated:

$${Γ}_{H , m , i} ( r ) = arg {min}_{Γ} {\sum }_{∀ {ω}_{n}} {\sum }_{∀ {x}_{k}} {‖ H ( r , j {ω}_{n} , {x}_{k} ) - {\sum }_{∀ m} {\sum }_{∀ i} {Γ}_{H , m , i} ( r ) {H}_{m , i} ( j {ω}_{n} , {x}_{k} ) ‖}^{2} ∀ m , ∀ i , r ∈ {V}_{F}$$

The modal vectorial field strength H_{m,i}(r, jω, x) can be determined at any location point r with the help of the modal distribution parameter Γ_{H,m,i}(r) and an effective modal field strength H_{m,i}(jω, x):

$${H}_{m , i} ( r , j ω , x ) = {Γ}_{H , m , i} ( r ) {H}_{m , i} ( j ω , x ) ∀ m , ∀ i$$

In this model, the modal distribution parameters Γ_{H,m,i}(r) are real, depend only on the location r, but are independent of the frequency ω and the displacement x.

In step 77, the normalized scalar product γ_{m,i,n,k}(r) is calculated between all combinations of the modal distribution parameters Γ_{H,m,i}(r) and Γ_{H,n,k}(r)

$${γ}_{m , i , n , k} ( r ) = \frac{〈 {Γ}_{H , m , i} ( r ) {Γ}_{H , n , k} ( r ) 〉}{‖ {Γ}_{H , m , i} ( r ) ‖ ‖ {Γ}_{H , n , k} ( r ) ‖} \begin{matrix}m , n ∈ \{ 1 , … , {M}_{T} \} \\ i , k ∈ \{ 1 , … , {I}_{m} \}\end{matrix}$$

taking into account the identity of the modal distribution parameters for equal indices:

$${Γ}_{H , m , i} ( r ) = {Γ}_{H , n , k} ( r ) \vert m = n , i = k ∀ m , ∀ i$$

If the magnitude of the scalar product |γ_{m,i,n,k}(r)|=1, then the distribution parameters point in the same or opposite direction, and the field lines are parallel to each other.

In step 75, a scalar, normalized field distribution function χ_{m,i}(r) of the subflux Φ_{m,i} in the iron component is determined using the norm of the modal distribution parameter Γ_{H,m,i}(r) and the volume V_{F} of the iron component:

$${χ}_{m , i} ( r ) = \frac{{‖ {H}_{m , i} ( r , j ω , x ) ‖}^{2}}{{\int }_{{V}_{F}} {‖ {H}_{m , i} ( r , j ω , x ) ‖}^{2} dV} = \frac{{‖ {Γ}_{H , m , i} ( r ) ‖}^{2}}{{\int }_{{V}_{F}} {‖ {Γ}_{H , m , i} ( r ) ‖}^{2} dV} ∀ m , ∀ i$$

In the following step 79, a parallel, modal coupling factor C_{P,m,i,n,k} is determined with the help of the scalar product and the field distribution functions, which captures the vectorial superposition of two parallel field strength components at all points r in the iron:

$${C}_{P , m , i , n , k} = \frac{{\int }_{{V}_{F}} {γ}_{m , i , n , k} ( r ) \sqrt{{χ}_{m , i} ( r ) {χ}_{n , k} ( r )} dV}{{\int }_{{V}_{F}} \sqrt{{χ}_{m , i} ( r ) {χ}_{n , k} ( r )} dV}$$

The product of the field distribution functions χ_{m,i}(r) and χ_{n,k}(r) weights the normalized scalar product. Since the normalized scalar product can occupy a real number between −1 and 1, the contributions from different points in the iron can partially compensate for each other. FIG. 6c) shows an example in which the local field strengths of the two modal magnet fluxes, Φ_{M,1} and Φ_{M,2}, in armature 25 altogether cancel each other out at the resting position x=0. FIG. 5c) shows another case in which the coil fluxes Φ_{C,1} and Φ_{C,2} flow separately near the upper and lower iron surfaces due to the skin effect at high audio frequencies, and x=0, and reduce the parallel coupling factor C_{P,m,i n,k} at higher frequencies.

In the following step 81, the orthogonal coupling factor C_{O,m,i,n,k} is determined with the help of the parallel, modal coupling factor C_{P,m,i,n,k}, which captures the vectorial superposition of two orthogonal field strength components in the iron:

$${C}_{O , m , i , n , k} = \sqrt{1 - {C}_{P , m , i , n , k}^{2}}$$

FIG. 1c) shows, for example, the coil flux Φ_{C,1} at x<0, which flows along the air gap due to the skin effect on the pole surfaces 4 and 6. However, the modal magnet flux Φ_{M,1} in FIG. 2c, flows at x<0 at right angles through the pole surfaces 4 and 6 and contributes to the orthogonal coupling factor C_{O,m,i,n,k} between the coil flux and the magnet flux.

In a further step 80, the energetic coupling factor C_{E,m,i,n,k} is determined with the help of the scalar field distribution functions χ_{m,i}(r) and χ_{n,k}(r):

$${C}_{E , m , i , n , k} = \frac{{\int }_{{V}_{F}} {χ}_{m , i} ( r ) {χ}_{n , k} ( r ) dV}{{\int }_{{V}_{F}} {{χ}_{m , i} ( r )}^{2} dV}$$

The energetic coupling factor C_{E,m,i,n,k} describes the coherence of the field distribution functions. For example, the magnet flux Φ_{M,3} in FIG. 6d generates a low energetic coupling with the magnet flux Φ_{M,1} in FIG. 6a. In contrast, the typical path of the magnet fluxes Φ_{M,1} and ΦM,2 through the armature 25 in FIG. 6b produces a higher energetic coupling factor.

In the last step 83, the three coupling factors C_{P,m,i,n,k}, C_{O,m,i,n,k}, and C_{E,m,i,n,k} are used to calculate the magnitude of the scalar, modal total field strength |H_{T,m,i}(t)|, which determines:

$$\vert {H}_{T , m , i} ( t ) \vert = \sqrt{{\vert {\sum }_{n = 1}^{{M}_{T}} {\sum }_{k = 1}^{{I}_{m}} {C}_{E , m , i , n , k} {C}_{P , m , i , n , k} {H}_{n , k} ( t ) \vert}^{2} + {\sum }_{n = 1}^{{M}_{T}} {\sum }_{k = 1}^{{I}_{m}} {( {C}_{E , m , i , n , k} {C}_{O , m , i , n , k} \vert {H}_{n , k} ( t ) \vert )}^{2}}$$

All coupling factors are constants and result from the special geometry and material properties of the transducer. They are calculated only once using FEM 71.

### Advantages of the Invention

The new method for reducing signal distortion in electromechanical transducers employs a modal decomposition of the magnetic field, combining the advantages of lumped-parameter network modelling and finite-element analysis.

This results in a model with modal systems connected in parallel, whose elements and internal states can be physically interpreted, capture orthogonal properties of the transducer, and whose complexity can be flexibly adapted to the transducer's specific properties. This enables sufficient accuracy with minimal effort in modeling. The modal structure is advantageous for a parallel implementation on several signal processors.

The modal model allows separation of displacement-dependent nonlinearities from the linear reluctance function and enables implementing static nonlinearities as power-series expansions and linear systems as IIR or FIR filters. It is also possible to describe the modal fluxes in iron more precisely with the help of the diffusion equation or the well-known hysteresis models.

The free parameters of the modal model can be determined using FEM simulations and electrical and mechanical measurements. The identified model enables evaluation of signal distortion, facilitates detection of dominant distortion sources, and supports improvements to transducer design. The new method can be applied to transducers of any complexity with several drive elements (e.g., voice coils, moving magnets).

1. Method for attenuating the linear and nonlinear signal distortions in an output signal of a passive electro-mechanical transducer using a movable, mechanical drive element, wherein a time-varying electric current i_{C} in a coil alters the magnetic field distribution in the transducer, generates a mechanical force Fₓ and a displacement x of the mechanical drive element, and a temporal change in the current i_{C} or displacement x causes an electrical induction voltage u_{I} in the coil; characterized by the steps:
I. Modelling of the magnetic flux distribution in the transducer as a sum of modal fluxes Φₘ, where static nonlinearities without memory are separated from linear dynamical systems with memory in each modal flux;
II. Determination of a number M_{T} of modal fluxes and identification of free parameters introduced by modeling based on measured electrical or mechanical signals at the transducer;
III. Determination of at least one modal flux Φₘ by means of a modal magnetomotive force Fₘ and a modal reluctance Rₘ; wherein at least one magnetomotive force Fₘ is described by means of a first modal nonlinearity N_{F,m}(x), which is a memoryless function of the displacement x; and the modal reluctance Rₘ captures the magnetic properties of the material through which the modal flux Φₘ flows, and the electrical conductivity of the material causes a memory and thus a frequency dependence of the modal reluctance;
IV. Determination of at least one linked modal flux λₘ with m=1, . . . , M_{T} by multiplying the modal flux Φₘ by a second modal nonlinearity N_{λ,m}(x);
V. Determination of the induction voltage u_{I} by temporal differentiation of the sum of all linked modal fluxes λₘ with m=1, . . . , M_{T};
VI. Determination of the mechanical force Fₓ using the modal fluxes Φₘ with m=1, . . . , M_{T};
VII. Determination of the displacement x by means of the mechanical force Fₓ; and
VIII. Reduction of signal distortions based on modelling and identified parameters by structurally changing the geometric and material properties of the passive transducer or by actively compensating for signal distortions with the help of electrical control.

2. The method of claim 1, wherein the passive electromechanical transducer uses a voice coil as the mechanical drive element, further comprising the steps:
I. Modelling of the modal fluxes Φₘ with m=1, . . . , M_{T}, where the fluxes contain at least one modal coil flux Φ_{C,m} with m=1, . . . , M_{C}, which describes the field generated by the current i_{C} in the coil; the fluxes contain a modal magnet flux Φ_{M,1} if the transducer uses a stationary magnet with an equivalent magnetizing current iₘ;
II. Determination of the modal coil flux Φ_{C,m}, by means of a modal magnetomotive force F_{C,m} and a modal coil flux reluctance R_{C,m}, the magnetomotive force F_{C,m} is generated by means of the current i_{C} and an effective modal number of turns N_{C,m}(x) of the voice coil, wherein the number of turns N_{C,m}(x) corresponds to the first modal nonlinearity N_{F-C,m}(x) of the coil flux Φ_{C,m}, and the modal coil flux reluctance R_{C,m} captures the magnetic properties of the material fluxing through the modal coil flux Φ_{C,m};
III. If the transducer contains a magnet, determination of a magnet flux Φ_{M,1} by means of a magnetomotive force F_{M,m} and a modal magnet flux reluctance R_{M,1} where the first modal nonlinearity N_{F-M,1}(x) of the magnet flux Φ_{M,1} is a constant, and the magnet flux reluctance R_{M,1} captures the magnetic properties of the materials through which the magnet flux Φ_{M,1} flows;
IV. If the transducer contains a magnet, determine a linked magnet flux λ_{M,1} by multiplying the modal magnet flux Φ_{M,1} by the second modal nonlinearity N_{λ-M,1}(x), which is determined by the effective modal number of turns N_{C,m}(x), and a modal linking constant C_{λ-M,m},
V. Determination of at least one linked modal coil flux λ_{C,m} with m=1, . . . , M_{C} by multiplying the modal coil flux Φ_{C,m} by the effective modal number of turns N_{C,m}(x) corresponding to the second modal nonlinearity N_{λ-C,m}(x);
VI. Determination of the induction voltage u_{I} by time differentiation of the sum of the linked coil fluxes λ_{C,m} with m=1, . . . , M_{C}, taking into account the linked magnet flux λ_{M,m}, if the transducer contains a magnet;
VII. Determination of the mechanical force Fₓ by means of at least one modal coil flux Φ_{C,m} and the magnet flux Φ_{M,m} if the transducer contains a magnet; and
VIII. Determination of the free parameters introduced by the modeling, in particular the modal coil flux reluctance R_{C,m} and the effective modal number of turns N_{C,m}(x) with m=1, . . . , M_{C} based on measured electrical or mechanical signals at the transducer.

3. The method of claim 1, wherein the passive electromechanical transducer uses a stationary coil and a movable magnet as the mechanical drive element; furthermore, comprising the steps:
I. Modelling of the modal fluxes Φₘ with m=1, . . . , M_{T}, where the modal fluxes contain a coil flux Φ_{C,1} describing the magnetic field generated by the current i_{C}, and at least one modal magnet flux Φ_{M,m} with m=1, . . . , M_{M} describing the field generated by the magnet;
II. Determination of the modal coil flux Φ_{C,1} by means of a magnetomotive force F_{C,1} and a coil flux reluctance R_{C,1}, wherein the magnetomotive force F_{C,1} is determined by means of the current i_{C} and a constant coil turn number N_{C}, and the coil flux reluctance R_{C,1} captures the magnetic properties of the material flowed through by the coil flux Φ_{C,1};
III. Determination of the modal magnet flux Φ_{M,m} by means of a modal magnetomotive force F_{M,m} and a modal magnet flux reluctance R_{M,m}, wherein the magnetomotive force F_{M,m} is determined by means of an equivalent magnetizing current iₘ of the magnet and the first modal nonlinearity N_{F-M,m}(x), which is a memoryless function of the displacement x; the modal magnet flux reluctance R_{M,m} captures the magnetic properties of the materials through which the modal magnet flux Φ_{M,m} flows;
IV. Determination of a linked coil flux λ_{C,1} by multiplying the coil flux Φ_{C,1} by the coil winding number N_{C};
V. Determination of at least one linked modal magnet flux λ_{M,m} for m=1, . . . , M_{M} by multiplying the modal magnet flux Φ_{M,m} by a constant modal value calculated by means of the coil winding number N_{C} and a modal linking constant C_{λ-M,m};
VI. Determination of the induction voltage u_{I} by temporal differentiation of the sum of the linked coil flux λ_{C-1} and the linked modal magnet fluxes λ_{C-M,m} with m=1, . . . , M_{M};
VII. Determination of the mechanical force Fₓ by means of the coil flux Φ_{C,1}, and at least one modal magnet flux Φ_{M,m}; and
VIII. Determination of the free parameters introduced by the modeling, in particular for the modal magnet flux reluctance R_{M,m}, and the first modal nonlinearity N_{F-M,m}(x) based on measured electrical or mechanical signals at the transducer.

4. The method of claim 1, wherein the passive electro-mechanical transducer comprises a stationary coil and uses a movable armature made of soft magnetic material as a mechanical drive element, further comprising the steps:
I. Modelling of the modal fluxes Φₘ with m=1, . . . , M_{T}, where the fluxes contain at least one modal coil flux Φ_{C,m} with m=1, . . . , M_{C}, which describes the field generated by the current i_{C}; if the transducer uses a stationary magnet, the modal fluxes contain at least one modal magnet flux Φ_{M,m} with m=1, . . . , M_{M}, which describes the field generated by the magnetization i_{M};
II. Determination of the modal coil flux Φ_{C,m} by means of a modal magnetomotive force F_{C,m} and a modal coil flux reluctance R_{C,m}; wherein the magnetomotive force F_{C,m} is determined by means of the current i_{C}, the modal coil flux Φ_{C,m}, a constant coil turn number N_{C}, and a modal air-gap nonlinearity R_{A,m}(x), wherein this air-gap nonlinearity R_{A,m}(x) describes the displacement-dependent and memoryless reluctance of the air gap; the modal coil flux reluctance R_{C,m} captures the magnetic properties of the reluctance of the materials passing through it outside the air gap;
III. If the transducer uses a magnet, determination of the modal magnet flux Φ_{M,m} by means of a modal magnetomotive force F_{M,m} and a modal magnet flux reluctance R_{M,m}; wherein the magnetomotive force F_{M,m} is determined by means of the magnetizing current i_{M}, the modal magnet flux Φ_{M,m} and the modal air gap nonlinearity R_{A,m}(x); the modal magnet flux reluctance R_{M,m} captures the linear magnetic properties of the materials flowing through the modal magnet flux Φ_{M,m},
IV. Determination of a linked modal coil flux λ_{C} by means of the modal coil flux Φ_{C,m}, with m=1, . . . , M_{C} multiplied by the coil winding number N_{C};
V. If the transducer contains a magnet, determination of a linked modal magnet flux λ_{M,m} by means of the modal magnet flux Φ_{M,m} by m=1, . . . , M_{M} multiplied by the coil number N_{C};
VI. Determination of the induction voltage u_{I} by time differentiation of at least one linked modal coil flux λ_{C,m}, taking into account at least one linked modal magnet flux λ_{M,m}, if the transducer contains a magnet;
VII. Determination of the mechanical force Fₓ by means of at least one modal coil flux Φ_{C,m} and at least one modal magnet flux Φ_{M,m}, if the transducer contains a magnet; and
VIII. Determination of the free modal parameters introduced by the modeling, in particular the magnet flux reluctance R_{M,m} and coil flux reluctance R_{C,m} and the air gap nonlinearity R_{A,m}(x) based on measured electrical or mechanical signals at the transducer.

5. The method of claim 1, wherein the following additional steps identify the free parameters of the model:
I. Positioning of the drive element at defined operating points xx with k=1, . . . , K;
II. Generation of a variable magnetomotive force Fₘ(xₖ, ωₙ) with the help of the current i_{C} in the coil or an alternating displacement x_{AC} of the drive element at defined frequencies ωₙ at the operating points xₖ of the drive element;
III. Measurement or numerical simulation of a total linked flux λ_{I}(jωₙ, xₖ) of the transducer at the frequencies ωₙ and operating points xₖ;
IV. Decomposition of the total linked flux λ_{I}(jωₙ, xₖ) into modes using a non-negative matrix factorization, whereby each mode m=1, . . . , M_{S} is described by a frequency-dependent vector Vₘ(jωₙ) and a displacement-dependent vector Wₘ(xₖ);
V. Selection of the dominant modes m=1, . . . , M_{C} with 1<M_{C}<M_{S} in non-negative matrix factorization, where the dominant modes approximate the total linked flux λ_{I}(jωₙ, xₖ) with a modeling error; and
VI. Generation of the first and second modal nonlinearities N_{F,m}(xₖ) and N_{λ,m}(xₖ) from the displacement-dependent vector Wₘ(xₖ) and determination of the modal reluctance function Rₘ(jωₙ) from the frequency-dependent vector Vₘ(jωₙ) of the dominant modes for m=1, . . . , M_{C}.

6. The method of claim 1, wherein the modal reluctance Rₘ for the modal flux Φₘ is determined by the following additional steps:
I. Modelling of the modal reluctance Rₘ using a modal network containing at least one series circuit of lumped elements, where the series circuit describes the reluctance of the materials on a closed field line with a modal subflux Φ_{m,i};
II. Determination of a real, frequency-independent, and time-invariant air reluctance r_{R,m,i} of a linear element representing the magnetic properties of air or magnet;
III. Determination of a ring reluctance function R_{L,m,i}(jω) of a linear element that increases proportionally with the frequency ω and produces an imaginary value, and takes into account the effect of induced currents in short-circuit rings and other conductive material with low permeability;
IV. Determination of a complex frequency-dependent iron reluctance function R_{F,m,i}(jω) of a linear element describing the modal magnet flux in an iron component, taking into account eddy currents and magnetic field displacement; and
V. Determination of a modal reluctance function Rₘ(jω) using the linear lumped elements of the modal network, where the reluctance function Rₘ(jω) approximates the modal reluctance Rₘ.

7. A method according to claim 6, wherein saturation, hysteresis, or other nonlinear material property of the iron component is captured in the modelling of modal reluctance Rₘ by the following additional steps:
I. Modeling of the nonlinear material properties with the help of at least one lumped flux source, which is connected in parallel to the linear element with the iron reluctance function R_{F,m,i}(jω) and feeds nonlinear signal distortions Φ_{F,m,i} into the modal subflux Φ_{m,i};
II. Determination of a modal magnetic voltage U_{m,i} generated by the modal subflux Φ_{m,i} via the iron reluctance function R_{F,m,i}(jω) by means of a linear approximation using the linear elements of the modal network and the modal magnetomotive force Fₘ.
III. Determination of a scalar, modal field strength H_{m,i} in the iron component based on the first magnetic voltage U_{m,i}, taking into account an effective length l_{m,i} of the iron path;
IV. Determination of a modal total field strength |H_{T,m,i}| in the iron component with the help of at least one modal field strength H_{m,i}, taking into account the vectorial coupling with other modal field strengths in the iron component;
V. Determination of scalar, modal total flux density |B_{T,m,i}| in the iron component from the total modal field strength |H_{T,m,i}| based on a material model describing the nonlinear relationship between the field strength and the flux density;
VI. Determination of a time-varying modal permeability μ_{m,i}(t) of the iron component penetrated by the subflux Φ_{m,i} using the total modal field strength |H_{T,m,i}| and total modal flux density |B_{T,m,i}|; and
VII. Determination of the nonlinear signal distortions Φ_{F,m,i} using the time-varying modal permeability λ_{m,i}(t), the modal magnetic voltage U_{m,i}(t), and the iron reluctance function R_{F,m,i}(jω).

8. The method of claim 7, wherein the total modal field strength |H_{T,m,i}| in the iron component is determined by the following additional steps:
I. Numerical simulation of the total vectorial magnetic field strength H(r, jωₙ, xₖ) as a function of the location r in the iron component, the frequency ωₙ, and the displacement xₖ based on the given geometry and defined material properties of the transducer;
II. Determination of a scalar, modal field strength H_{m,i}(jωₙ, xₖ) at the selected frequency ωₙ and the displacement xₖ by means of modal modeling;
III. Optimal estimation of at least one vectorial, modal distribution parameter Γ_{H,m,i}(r) by minimizing the quadratic error between the total vectorial magnetic field strength H(r, jωₙ, xₖ) and a modal development of the total vectorial field strength using the scalar, modal field strength H_{m,i}(jωₙ, xₖ);
IV. Determination of a normalized scalar product γ_{m,i,n,k}(r) between combinations of two modal distribution parameters Γ_{H,m,i}(r) and Γ_{H,n,k}(r);
V. Determination of a scalar, modal field distribution function χ_{m,i}(r) using the norm of the modal distribution parameter Γ_{H,m,i}(r) of the iron component;
VI. Determination of a parallel coupling factor C_{P,m,i,n,k} using the normalized scalar product γ_{m,i,n,k}(r) and the scalar, modal field distribution function χ_{m,i}(r), where the parallel coupling factor C_{P,m,i,n,k} describes the vectorial superposition of two parallel field strength components in the iron;
VII. Determination of an orthogonal coupling factor C_{O,m,i,n,k} using the parallel coupling factor C_{P,m,i,n,k}, where the orthogonal coupling factor C_{O,m,i,n,k} describes the vectorial superposition of two orthogonal field strength components in the iron;
VIII. Determination of an energetic coupling factor C_{E,m,i,n,k} with the help of two scalar, modal field distribution functions χ_{m,i}(r) and χ_{n,k}(r), where the energetic coupling factor C_{E,m,i,n,k} captures the energetic coherence of the scalar, modal field distribution functions in the iron; and
IX Determination of the total scalar modal field strength |H_{T,m,i}(t)| in the iron component as the energetic sum of a parallel part and an orthogonal part, wherein the parallel part is determined by the weighting of at least one modal field strength H_{n,k}(t) with the parallel coupling factor C_{P,m,i,n,k}, and the energetic coupling factor C_{E,m,i,n,k} and the orthogonal portion is determined by weighting the magnitude of at least one modal field strength |(H_{n,k}(t)| with the orthogonal coupling factor C_{O,m,i,n,k} and the energetic coupling factor C_{E,m,i,n,k}.

9. The method of claim 1, wherein the mechanical force Fₓ is determined by means of the modal fluxes Φₘ by the following additional steps:
I. Generation of modal fluxes Om, which flow on stationary flux lines and have a fixed connection to the immovable components of the transducer;
II. Determination of the weighted total flux, on an envelope surface in air around the mechanical drive element, using the modal fluxes Φₘ and modal weighting parameters C_{F,m}, wherein the weighting parameters C_{F,m} describe the permeability of the air, the geometry of the envelope surface, and the coupling of the fluxes Φₘ with the envelope surface; and
III. Generation of the mechanical force Fₓ by squaring the total weighted flux and then partial dissipation after the displacement x.

10. A method according to claim 1, wherein the constructive modification of the geometric and material-related properties of the passive transducer further comprises the following steps:
I. Providing a typical input signal that corresponds to the practical application of the transducer;
II. Simulation of the output signal of the transducer for the typical input signal based on the modal modeling of the electro-mechanical transducer;
III. Separation of the nonlinear distortions from the linear signal components in the output signal and simulation of the distortion components, which describe the individual displacement-dependent nonlinearities and the nonlinear permeability of the iron component;
IV. Identification of a critical nonlinearity that causes the dominant signal distortions in the output signal; and
V. Identify the design causes of the critical nonlinearity and make practical improvements to the transducer.

11. The method of claim 10, wherein the passive transducer is an actuator with an electrical input u_{C}, and the electrical control further comprises the following steps:
I. Simulation of the nonlinear distortions in the output signal x_{D} based on modal modeling of the magnetic flux, taking into account the critical nonlinearity generated by the dominant distortions in the output signal;
II. Transformation of the nonlinear distortions in the output signal x_{D} into equivalent distortions up at the electrical input of the transducer;
III. Generation of electrical compensation distortions u_{K} based on the modeling of the transducer with modal fluxes Φₘ with m=1, . . . , M_{T}, where the compensation distortions correspond to the equivalent distortions with negated sign; and
IV. Generating a control signal u_{S} by adding the compensation distortions u_{K} to the undistorted input signal w and providing the control signal u_{S} to the electrical input u_{C}.
